(19) United States
(12) Patent Application Publication
(10) Pub. No.: US 2026/0186205 A1
(43) Pub. Date: Jul. 2, 2026

(54) STRUCTURES INCLUDING A WAVEGUIDE CORE WITH A DIELECTRIC-FILLED SLOTTED REGION

(71) Applicant: GlobalFoundries U.S. Inc., Malta, NY (US)

(72) Inventor: Yusheng Bian, Ballston Lake, NY (US)

(21) Appl. No.: 19/007,894

(22) Filed: Jan. 2, 2025

(51) Int. Cl. G02B 6/122; G02B 6/12; G02B 6/125; G02B 6/13

(52) U.S. Cl. CPC G02B 6/1228; G02B 6/125; G02B 6/13; G02B 2006/12061; G02B 2006/12109; G02B 2006/12142; G02B 2006/12147; G02B 2006/12164

(57) ABSTRACT

Structures for a photonic chip that include a waveguide core and methods of forming such structures. The structure comprises a waveguide core including a slot and a dielectric layer inside the slot. The waveguide core comprises a material having a first refractive index, and the dielectric layer comprises a dielectric material having a second refractive index that is less than the first refractive index.

### BACKGROUND

The disclosure relates to photonic chips and, more specifically, to structures for a photonic chip that include a waveguide core and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as a laser or an optical fiber.

Waveguide cores are utilized on the photonic chip to form the photonic components of the photonic integrated circuit and to connect the photonic components of the photonic integrated circuit. However, waveguide cores may be highly sensitive to fabrication variations. For example, fabrication variations for waveguide cores used in photonic components may result in performance degradation, such as a significant channel drift in a modulator. The performance degradation may be particularly significant if the waveguide cores are fabricated from silicon nitride.

Improved structures including a waveguide core and methods of forming such structures are needed.

### SUMMARY

In an embodiment of the invention, a structure for a photonics chip is provided. The structure comprises a waveguide core including a slot and a dielectric layer inside the slot. The waveguide core comprises a material having a first refractive index, and the dielectric layer comprises a dielectric material having a second refractive index that is less than the first refractive index.

In an embodiment of the invention, a method of forming a structure for a photonic chip is provided. The method comprises forming a first waveguide core including a slot and forming a dielectric layer that includes a portion positioned inside the slot. The first waveguide core comprises a material having a first refractive index, and the dielectric layer comprises a dielectric material having a second refractive index that is less than the first refractive index.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a diagrammatic view of a wavelength-division-multiplexing filter in accordance with embodiments of the invention.

FIG. 2 is a top view of a structure at an initial fabrication stage of a processing method in accordance with embodiments of the invention.

FIG. 2A is a cross-sectional view taken generally along line 2A-2A in FIG. 2.

FIG. 2B is a cross-sectional view taken generally along line 2B-2B in FIG. 2.

FIGS. 3A, 3B are cross-sectional views of the structure at a fabrication stage of the processing method subsequent to FIGS. 2, 2A, 2B.

FIG. 4 is a top view of a structure in accordance with alternative embodiments of the invention.

FIG. 4A is a cross-sectional view taken generally along line 4A-4A in FIG. 4.

FIG. 4B is a cross-sectional view taken generally along line 4B-4B in FIG. 4.

FIGS. 4, 4A are cross-sectional views of a structure in accordance with alternative embodiments of the invention.

FIGS. 5A, 5B are cross-sectional views of a structure in accordance with alternative embodiments of the invention.

### DETAILED DESCRIPTION

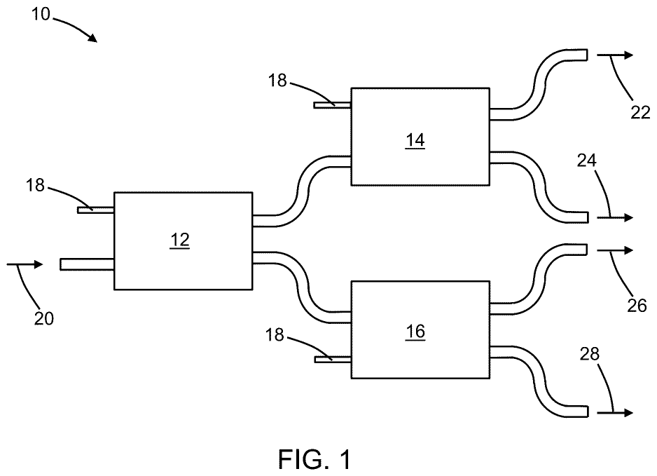

With reference to FIG. 1 and in accordance with embodiments of the invention, a wavelength-division-multiplexing filter 10 includes a filter stage 12 and a pair of filter stages 14, 16 that are coupled by waveguides to the filter stage 12. Each of the filter stages 12, 14, 16 includes an open terminal that may be coupled with a terminator 18, which may be an absorber or a grating coupler. In alternative embodiments, additional channels may be added to the wavelength-division-multiplexing filter 10 by cascading together additional filter stages with the filter stages 12, 14, 16. For example, a set of four additional filter stages may be coupled to the outputs from the filter stages 14, 16. In an embodiment, the wavelength-division-multiplexing filter 10 may enable coarse wavelength-dependent demultiplexing or multiplexing. In an embodiment, the wavelength-division-multiplexing filter 10 may enable dense wavelength-dependent demultiplexing or multiplexing. The wavelength-division-multiplexing filter 10, in any of its embodiments described herein, may be integrated into the photonic integrated circuit of a photonic chip.

The wavelength-division-multiplexing filter 10 is a multiple-channel device that may be configured to receive light 20 from a waveguide core at an input to the filter stage 12. The light 20 may include mixed optical signals of multiple different wavelengths in a multi-wavelength data stream. For example, light 20 may be characterized by multiple different wavelengths within the near infrared portion (e.g., 850 nanometers to 1650 nanometers) of the electromagnetic spectrum. In the representative embodiment, the wavelength-division-multiplexing filter 10 may be configured to receive light with four different wavelengths, namely optical signals 22, optical signals 24, optical signals 26, and optical signals 28. The filter stages 12, 14, 16 of the wavelength-division-multiplexing filter 10 may split or divide the light 20 according to wavelength. The filter stage 12 may separate the optical power for optical signals 22, 24 (e.g., odd wavelengths) from the optical power for the optical signals 26, 28 (e.g., even wavelengths). The portion of the light 20 included in the optical signals 22, 24 may be provided by a linking waveguide core from an output of the filter stage 12 to an input to the filter stage 14, and the portion of the light 20 included in the optical signals 26, 28 may be provided by a linking waveguide core from another output of the filter stage 12 to an input to the filter stage 16. The filter stage 14 separates the optical power for the optical signals 22 from the optical power for the optical signals 24, directs the portion of the light 20 included in the optical signals 22 to a waveguide core at an output, and directs the portion of the light 20 included in the optical signals 24 to a waveguide core at a different output. The filter stage 16 separates the optical power for the optical signals 26 from the optical power for the optical signals 28, directs the portion of the light 20 included in the optical signals 26 to a waveguide core at an output, and directs the portion of the light 20 included in the optical signals 28 to a waveguide core at a different output.

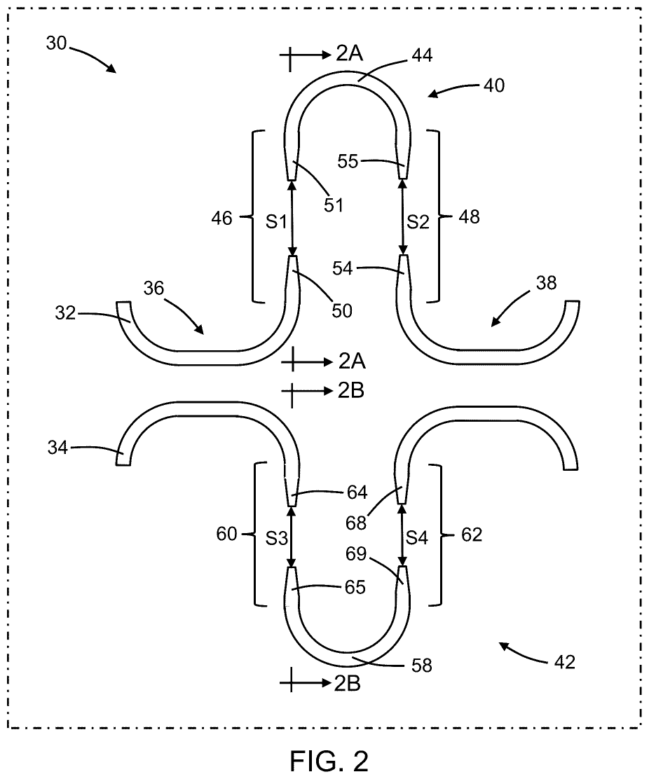

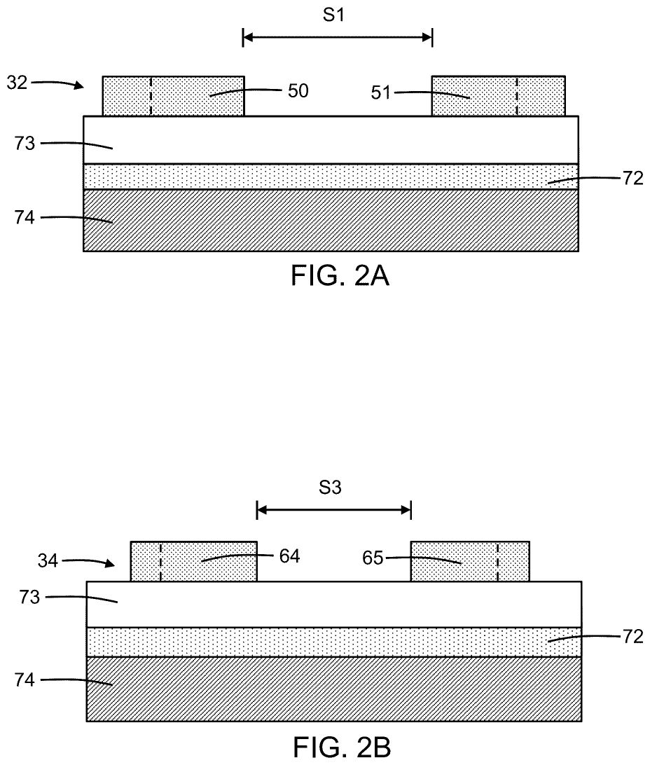

With reference to FIGS. 2, 2A, 2B and in accordance with embodiments of the invention, a structure 30 for a photonic chip includes a waveguide core 32 and a waveguide core 34 that are positioned in a vertical direction over a dielectric layer 72, a dielectric layer 73, and a semiconductor substrate 74. In an embodiment, the dielectric layers 72, 73 may be comprised of a dielectric material, such as silicon dioxide, and the semiconductor substrate 74 may be comprised of a semiconductor material, such as single-crystal silicon. In an embodiment, the dielectric layer 72 may be a buried oxide layer of a silicon-on-insulator substrate, and the dielectric layers 72, 73 may be positioned between the waveguide cores 32, 34 and the semiconductor substrate 74. In an alternative embodiment, the dielectric layer 73 may be omitted such that only the dielectric layer 72 is positioned between the waveguide cores 32, 34 and the semiconductor substrate 74.

The structure 30 may be deployed in a Mach-Zehnder modulator included in a photonic integrated circuit formed on a photonic chip. For example, one or more instances of the structure 30 may be deployed as a Mach-Zehnder modulator in each of the filter stages 12, 14, 16 of the wavelength-division-multiplexing filter 10 (FIG. 1).

The waveguide cores 32, 34 may be routed to include adjacent sections that define a directional coupler 36 and adjacent sections that define a directional coupler 38. The waveguide core 32 includes a phase delay arm 40 that is joined by a bend to the section of the waveguide core 32 participating in the directional coupler 36 and that is joined by another bend to the section of the waveguide core 32 participating in the directional coupler 38. Similarly, the waveguide core 34 includes a phase delay arm 42 that is joined by a bend to the section of the waveguide core 34 participating in the directional coupler 36 and that is joined by another bend to the section of the waveguide core 34 participating in the directional coupler 38. In a representative embodiment, the bends joining the directional couplers 36, 38 to the phase delay arms 40, 42 may extend over an arc equal to about 90°. The total length and associated optical path of the phase delay arm 40 may differ from the total length and associated optical path of the phase delay arm 42. In an embodiment, the total length and associated optical path of the phase delay arm 40 may be greater than the total length and associated optical path of the phase delay arm 42. In an alternative embodiment, the directional couplers 36, 38 may be replaced by a different type of optical coupler, such as a multi-mode interference coupler.

The phase delay arm 40 of the waveguide core 32 includes a section 44, a section 46 between the directional coupler 36 and the section 44, and a section 48 between the directional coupler 38 and the section 44. In an embodiment, the section 44 of the phase delay arm 40 may curve in a bend to connect the sections 46, 48 of the phase delay arm 40. In a representative embodiment, the section 44 may be a semicircular bend and may extend over an arc equal to about 180°.

The section 46 of the phase delay arm 40 includes a taper 50, a taper 51, and a slot S1 that are positioned in a group between the directional coupler 36 and the section 44 of the phase delay arm 40. The slot S1 is positioned along the length of the section 46 between the taper 50 and the taper 51, the taper 50 is positioned along the length of the section 46 between the slot S1 and the directional coupler 38, and the taper 51 is positioned along the length of the section 46 between the slot S1 and the section 44. The taper 50 is fully disconnected from the taper 51, and the tapers 50, 51 represent portions of the waveguide core 32 that adjoin the slot S1. The slot S1 represents a discontinuity in the waveguide core 32 between the end of the taper 50 and the end of the taper 51 that extends fully through the waveguide core 32 to the dielectric layer 73 and fully across a width dimension the waveguide core 32. In an embodiment, the width dimension of the tapers 50, 51 may increase with increasing distance from the slot S1. In an embodiment, the tapers 50, 51 may include a single stage of tapering characterized by a taper angle. In an alternative embodiment, the tapers 50, 51 may taper in multiple stages each characterized by a different taper angle. In an alternative embodiment, the tapers 50, 51 may be divided into multiple segments. In an alternative embodiment, the tapers 50, 51 may be replaced by non-tapered portions of the section 46, and the slot S1 may be positioned between the non-tapered portions of the section 46.

The section 48 of the phase delay arm 40 includes a taper 54, a taper 55, and a slot S2 that are positioned in a group between the directional coupler 36 and the section 44 of the phase delay arm 40. The slot S2 is positioned along the length of the section 48 between the taper 54 and the taper 55, the taper 54 is positioned along the length of the section 48 between the slot S2 and the directional coupler 38, and the taper 55 is positioned along the length of the section 48 between the slot S2 and the section 44. The taper 54 is fully disconnected from the taper 55, and the tapers 54, 55 represent portions of the waveguide core 32 that adjoin the slot S2. The slot S2 represents a discontinuity in the waveguide core 32 between the end of the taper 54 and the end of the taper 55 that extends fully through the waveguide core 32 to the dielectric layer 73 and fully across a width dimension of the waveguide core 32. In an embodiment, the width dimension of the tapers 54, 55 may increase with increasing distance from the slot S2. In an embodiment, the tapers 54, 55 may include a single stage of tapering characterized by a taper angle. In an alternative embodiment, the tapers 54, 55 may taper in multiple stages each characterized by a different taper angle. In an alternative embodiment, the tapers 54, 55 may be divided into multiple segments. In an alternative embodiment, the tapers 54, 55 may be replaced by non-tapered portions of the section 48, and the slot S2 may be positioned between the non-tapered portions of the section 48.

The phase delay arm 42 includes a section 58, a section 60 between the directional coupler 36 and the section 58, and a section 62 between the directional coupler 38 and the section 58. In an embodiment, the section 58 of the phase delay arm 42 may curve in a bend to connect the sections 60, 62 of the phase delay arm 42. In a representative embodiment, the section 58 may be a semicircular bend and may extend over an arc equal to about 180°.

The section 60 of the phase delay arm 42 includes a taper 64, a taper 65, and a slot S3 that are positioned in a group between the directional coupler 36 and the section 58 of the phase delay arm 42. The slot S3 is positioned along the length of the section 60 between the taper 64 and the taper 65, the taper 64 is positioned along the length of the section 60 between the slot S3 and the directional coupler 38, and the taper 65 is positioned along the length of the section 60 between the slot S3 and the section 58. The taper 64 is fully disconnected from the taper 65, and the tapers 64, 65 represent portions of the waveguide core 34 that adjoin the slot S3. The slot S3 represents a discontinuity in the waveguide core 34 between the end of the taper 64 and the end of the taper 65 that extends fully through the waveguide core 34 to the dielectric layer 73 and fully across a width dimension the waveguide core 34. In an embodiment, the width of the tapers 64, 65 may increase with increasing distance from the slot S3. In an embodiment, the tapers 64, 65 may include a single stage of tapering characterized by a taper angle. In an alternative embodiment, the tapers 64, 65 may taper in multiple stages each characterized by a different taper angle. In an alternative embodiment, the tapers 64, 65 may be divided into multiple segments. In an alternative embodiment, the tapers 64, 65 may be replaced by non-tapered portions of the section 60, and the slot S3 may be positioned between the non-tapered portions of the section 60.

The section 62 of the phase delay arm 42 includes a taper 68, a taper 69, and a slot S4 that are positioned in a group between the directional coupler 36 and the section 58 of the phase delay arm 42. The slot S4 is positioned along the length of the section 62 between the taper 68 and the taper 69, the taper 68 is positioned along the length of the section 62 between the slot S4 and the directional coupler 38, and the taper 69 is positioned along the length of the section 62 between the slot S4 and the section 58. The taper 68 is fully disconnected from the taper 69, and the tapers 68, 69 represent portions of the waveguide core 34 that adjoin the slot S4. The slot S4 represents a discontinuity in the waveguide core 34 between the end of the taper 68 and the end of the taper 69 that extends fully through the waveguide core 34 to the dielectric layer 73 and fully across a width dimension the waveguide core 34. In an embodiment, the width of the tapers 68, 69 may increase with increasing distance from the slot S4. In an embodiment, the tapers 68, 69 may include a single stage of tapering characterized by a taper angle. In an alternative embodiment, the tapers 68, 69 may taper in multiple stages each characterized by a different taper angle. In an alternative embodiment, the tapers 68, 69 may be divided into multiple segments. In an alternative embodiment, the tapers 68, 69 may be replaced by non-tapered portions of the section 62, and the slot S4 may be positioned between the non-tapered portions of the section 62.

The slot S1 may have a length between the taper 50 and the taper 51 that is along the direction for light propagation in the waveguide core 32, as well as along the length of the phase delay arm 40. The slot S2 may have a length between the taper 54 and the taper 55 that is along the direction for light propagation in the waveguide core 32, as well as along the length of the phase delay arm 40. In an embodiment, the slot S1 and the slot S2 may have equal lengths. In an embodiment, the slot S1 and the slot S2 may have unequal lengths. For example, the slot S2 may have a length that is less than the length of the slot S1.

The slot S3 may have a length between the taper 64 and the taper 65 that is along the direction for light propagation in the waveguide core 34, as well as along the length of the phase delay arm 42. The slot S4 may have a length between the taper 68 and the taper 69 that is along the direction for light propagation in the waveguide core 34, as well as along the length of the phase delay arm 42. In an embodiment, the slot S3 and the slot S4 may have equal lengths. In an embodiment, the slot S3 and the slot S4 may have unequal lengths. For example, the slot S3 may have a length that is less than the length of the slot S4.

In an embodiment, the lengths of the slot S3 and the slot S4 may be differ from the lengths of the slot S1 and the slot S2. In an embodiment, the lengths of the slot S3 and the slot S4 may be less than the lengths of the slot S1 and the slot S2.

In an embodiment, the waveguide cores 32, 34 may be comprised of a material having a refractive index that is greater than the refractive index of silicon dioxide. In an embodiment, the waveguide cores 32, 34 may be comprised of a dielectric material, such as silicon nitride. In an alternative embodiment, the waveguide cores 32, 34 may be comprised of a different dielectric material, such as silicon oxynitride or aluminum nitride. In an alternative embodiment, the waveguide cores 32, 34 may be comprised of a semiconductor material, such as single-crystal silicon, amorphous silicon, or polycrystalline silicon. In alternative embodiments, other materials, such as a polymer or a III-V compound semiconductor, may be used to form the waveguide cores 32, 34.

In an embodiment, the waveguide cores 32, 34 may be formed by patterning a layer of material with lithography and etching processes. In an embodiment, the waveguide cores 32, 34 may be formed by patterning a deposited layer of a material (e.g., silicon nitride). In an alternative embodiment, the waveguide cores 32, 34 may be formed by patterning the semiconductor material (e.g., single-crystal silicon) of a device layer of a silicon-on-insulator substrate. In an alternative embodiment, the waveguide cores 32, 34 may include stacked layers comprised of different materials, such as a layer of silicon nitride overlying a layer of silicon.

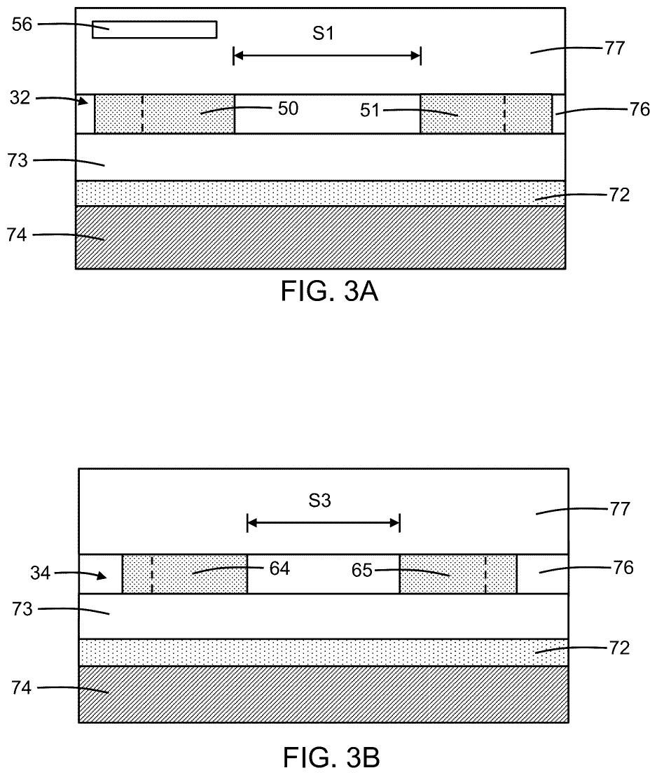

With reference to FIGS. 3A, 3B and at a fabrication stage subsequent to FIGS. 2, 2A, 2B, a dielectric layer 76 may be formed over the waveguide cores 32, 34. The dielectric layer 76 may be comprised of a dielectric material that is deposited and then planarized following deposition. The dielectric material constituting the dielectric layer 76 has a refractive index that is less than the refractive index of the material constituting the waveguide cores 32, 34. In an embodiment, the dielectric material of the dielectric layer 76 may be comprised of an oxide, silicon dioxide, borophosphosilicate glass, tetraethylorthosilicate silicon dioxide, or fluorinated-tetraethylorthosilicate silicon dioxide, spin-on glass, undoped silicate glass, fluorinated silicate glass, high-density plasma oxide, or plasma-enhanced tetraethylorthosilicate silicon dioxide.

A back-end-of-line stack 77 may be formed over the dielectric layer 76. The back-end-of-line stack 77 may include stacked dielectric layers in which each dielectric layer is comprised of a dielectric material, such as silicon dioxide, silicon nitride, tetraethylorthosilicate silicon dioxide, or fluorinated-tetraethylorthosilicate silicon dioxide.

A portion of the dielectric layer 76 inside the slot S1 effectively represents a layer comprised of dielectric material that is positioned between the narrow end of the taper 50 and the narrow end of the taper 51. The refractive index of the section 46 of the phase delay arm 40 changes at the transitions from the material constituting the waveguide core 32 to the lower-index dielectric material inside the slot S1 between the tapers 50, 51. The dielectric material inside the slot S1 has a length equal to the length of the slot S1.

A portion of the dielectric layer 76 inside the slot S2 effectively represents a layer comprised of dielectric material that is positioned between the narrow end of the taper 54 and the narrow end of the taper 55. The refractive index of the section 46 of the phase delay arm 40 changes at the transitions from the material constituting the waveguide core 32 to the lower-index dielectric material inside the slot S2 between the tapers 54, 55. The dielectric material inside the slot S2 has a length equal to the length of the slot S2.

A portion of the dielectric layer 76 inside the slot S3 effectively represents a layer comprised of dielectric material that is positioned between the narrow end of the taper 64 and the narrow end of the taper 65. The refractive index of the section 60 of the phase delay arm 42 changes at the transitions from the material constituting the waveguide core 34 to the lower-index dielectric material inside the slot S3 between the tapers 64, 65. The dielectric material inside the slot S3 has a length equal to the length of the slot S3.

A portion of the dielectric layer 76 inside the slot S4 effectively represents a layer comprised of dielectric material that is positioned between the narrow end of the taper 68 and the narrow end of the taper 69. The refractive index of the section 60 of the phase delay arm 42 changes at the transitions from the material constituting the waveguide core 34 to the lower-index dielectric material inside the slot S4 between the tapers 68, 69. The dielectric material inside the slot S4 has a length equal to the length of the slot S4.

In an alternative embodiment, a sealed undercut may be formed in the semiconductor substrate 74 beneath the slot S1, the slot S2, the slot S3, and/or the slot S4. In an alternative embodiment, a heater 56 may be formed in the back-end-of-line stack 77 adjacent to the slot S1 and, optionally, similar heaters may be formed in the back-end-of-line stack 77 adjacent to the slot S2, the slot S3, and/or the slot S4. The heater 56 may be comprised of a metal, such as titanium nitride. In an alternative embodiment, the slot S2 may be omitted such that the section 48 of the phase delay arm 40 lacks discontinuities. In an alternative embodiment, the slot S4 may be omitted such that the section 62 of the phase delay arm 42 lack discontinuities.

In use, light is input into the directional coupler 36 via either the waveguide core 32 or the waveguide core 34, and the directional coupler 36 splits the light between the waveguide core 32 and the waveguide core 34. A portion of the split light propagates in the phase delay arm 40 of the waveguide core 32 and another portion of the split light propagates the phase delay arm 42 of the waveguide core 34. Light traveling in the phase delay arm 40 of the waveguide core 32 propagates in the dielectric material inside the slot S1 between the tapers 50, 51 and the dielectric material inside the slot S2 between the tapers 54, 55. Light traveling in the phase delay arm 42 of the waveguide core 34 propagates in the dielectric material inside the slot S3 between the tapers 64, 65 and the dielectric material inside the slot S4 between the tapers 68, 69. The difference in the lengths of the optical path in phase delay arm 40 and the optical path in phase delay arm 42 provides phase modulation, which results in intensity modulation at the output from the directional coupler 38.

The length of the phase delay arm 40, the length of the phase delay arm 42, the splitting ratio of the directional coupler 36, and the splitting ratio of the directional coupler 38 can be varied to vary the performance of a Mach-Zehnder modulator embodied in the structure 30 or, alternatively, to target the Mach-Zehnder modulator embodied in the structure 30 for deployment in a specific application, such as use in one of the filter stages 12, 14, 16 of the wavelength-division-multiplexing filter 10 (FIG. 1). Due to the introduction of the slots S1, S2, S3, S4 that are filled by lower-index dielectric material, the structure 30 embodied in the Mach-Zehnder modulator may be characterized by an improved tolerance to fabrication variations. In that regard, the introduction of the slots S1, S2, S3, S4 that are filled by low-index dielectric material may cause the waveguide mode effective index and group index to be less sensitive to variations in the thickness of the waveguide cores 32, 34 and/or variations in the refractive index of the material constituting the waveguide cores 32, 34.

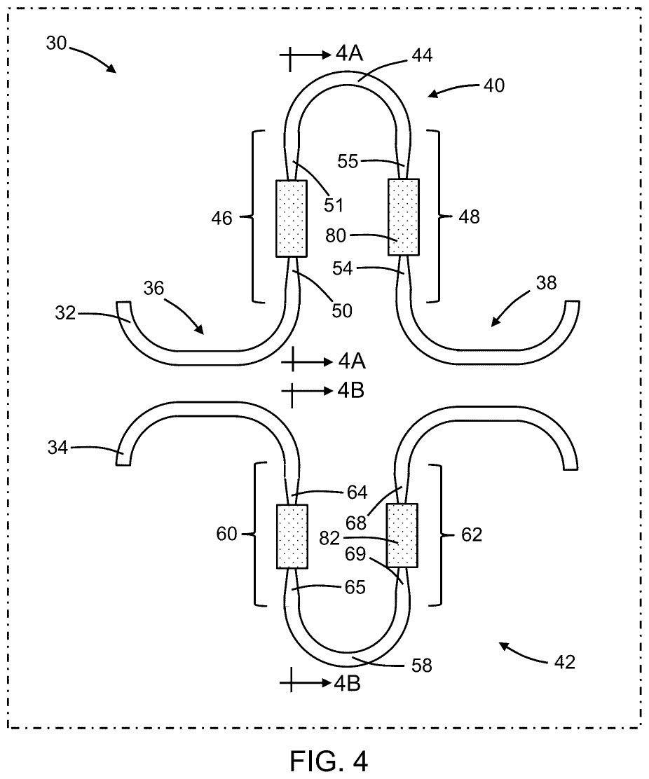

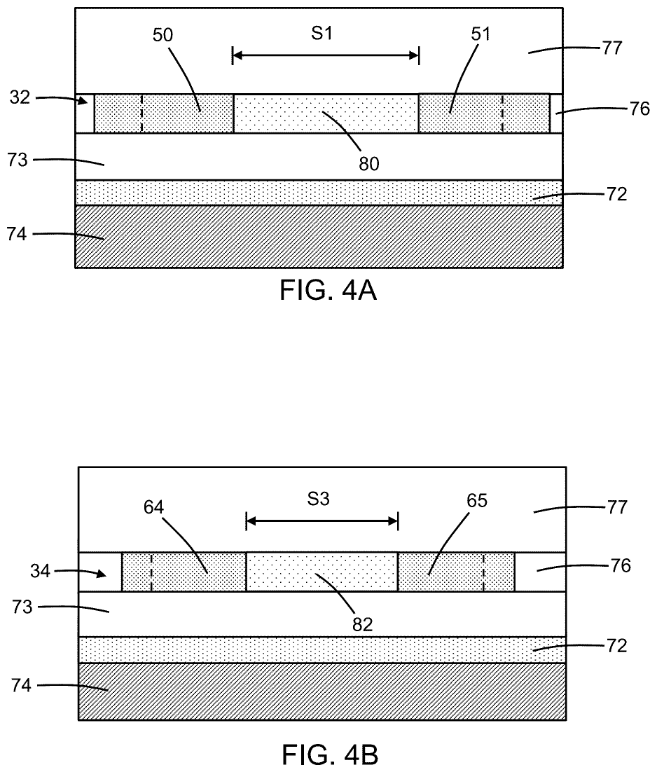

With reference to FIGS. 4, 4A, 4B and in accordance with alternative embodiments of the invention, the slot S1 and the slot S2 may be filled by portions of a dielectric layer 80 as illustrated for slot S1 in FIG. 4, and the slot S3 and the slot S4 may be filled by portions of a dielectric layer 82 as illustrated for slot S3 in FIG. 4A. In an embodiment, the dielectric layer 80 may be comprised of the same dielectric material as the dielectric layer 82. In an embodiment, the dielectric layer 80 may be comprised of a different dielectric material from the dielectric layer 82.

The dielectric layer 80 and the dielectric layer 82 are comprised of different dielectric materials than the dielectric layer 76. The dielectric layer 80 may be formed by patterning trenches in the dielectric layer 76 between the tapers 50, 51 and between the tapers 54, 55, depositing the constituent dielectric material, and then planarizing the deposited dielectric material. The dielectric layer 82 may be formed by patterning trenches in the dielectric layer 76 between the tapers 64, 65 and between the tapers 68, 69, depositing the constituent dielectric material, and then planarizing the deposited dielectric material. In an embodiment, the dielectric layer 80 and the dielectric layer 82 may be concurrently formed if comprised of the same dielectric material. In an alternative embodiment, the dielectric layer 80 and the dielectric layer 82 may be sequentially formed if comprised of different dielectric materials.

The dielectric material constituting the dielectric layer 80 has a refractive index that is less than the refractive index of the material constituting the waveguide core 32. The dielectric material constituting the dielectric layer 82 has a refractive index that is less than the refractive index of the material constituting the waveguide core 34. In an embodiment, the dielectric material of the dielectric layer 80 and the dielectric material of the dielectric layer 82 may be comprised of an oxide, silicon dioxide, borophosphosilicate glass, tetraethylorthosilicate silicon dioxide, or fluorinated-tetraethylorthosilicate silicon dioxide, spin-on glass, undoped silicate glass, fluorinated silicate glass, high-density plasma oxide, or plasma-enhanced tetraethylorthosilicate silicon dioxide.

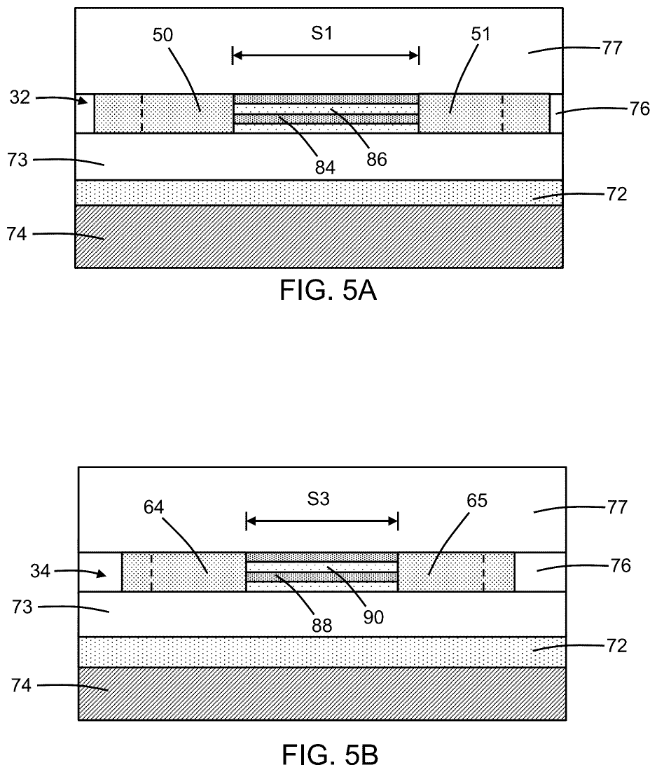

With reference to FIGS. 5A, 5B and in accordance with alternative embodiments of the invention, the slot S1 and the slot S2 may be filled by portions of a layer stack that includes dielectric layers 84, 86 as illustrated for slot S1 in FIG. 4, and the slot S3 and the slot S4 may be filled by portions of a layer stack that includes dielectric layers 88, 90, as illustrated for slot S3 in FIG. 4A. In an embodiment, the dielectric layers 84 may be comprised of the same dielectric material as the dielectric layers 88, and the dielectric layers 86 may be comprised of the same material as the dielectric layers 90. In an embodiment, the dielectric layers 84 may be comprised of a different dielectric material than the dielectric layers 88. In an embodiment, the dielectric layers 86 may be comprised of a different dielectric material than the dielectric layers 90. The dielectric layers 84, 86 may be arranged in a repeating pattern within the layer stack in which the type of dielectric material alternates in a vertical direction, and the dielectric layers 88, 90 may be arranged in a repeating pattern within the layer stack in which the type of dielectric material alternates in a vertical direction.

The dielectric layers 84, 86 and the dielectric layers 88, 90 may be comprised of different dielectric materials than the dielectric layer 76. The dielectric layers 84, 86 may be formed by patterning trenches in the dielectric layer 76 between the tapers 50, 51 and between the tapers 54, 55, sequentially depositing the constituent dielectric materials, and then planarizing the deposited dielectric materials. The dielectric layers 88, 90 may be formed by patterning trenches in the dielectric layer 76 between the tapers 64, 65 and between the tapers 68, 69, sequentially depositing the constituent dielectric materials, and then planarizing the deposited dielectric materials.

The dielectric materials constituting the dielectric layers 84, 86 have a refractive index that is less than the refractive index of the material constituting the waveguide core 32. The dielectric materials constituting the dielectric layers 88, 90 have a refractive index that is less than the refractive index of the material constituting the waveguide core 34. In an embodiment, the dielectric materials of the dielectric layers 84, 86 and the dielectric materials of the dielectric layer 88, 90 may be comprised of an oxide, silicon dioxide, borophosphosilicate glass, tetraethylorthosilicate silicon dioxide, or fluorinated-tetraethylorthosilicate silicon dioxide, spin-on glass, undoped silicate glass, fluorinated silicate glass, high-density plasma oxide, or plasma-enhanced tetraethylorthosilicate silicon dioxide.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a photonics chip, the structure comprising:
a first waveguide core including a first slot, the first waveguide core comprising a material having a first refractive index; and
a first dielectric layer inside the first slot, the first dielectric layer comprising a first dielectric material having a second refractive index that is less than the first refractive index.

2. The structure of claim 1 wherein the first waveguide core includes a first taper and a second taper, and the first slot is positioned between the first taper and the second taper.

3. The structure of claim 2 wherein the first taper has a first end adjacent to the first slot and a first width dimension that increases with increasing distance from the first end, and the second taper has a second end adjacent to the first slot and a second width dimension that increases with increasing distance from the second end.

4. The structure of claim 3 wherein the first end of the first taper and the second end of the second taper are fully separated by the first dielectric layer in the first slot.

5. The structure of claim 1 wherein the first dielectric layer comprises a second dielectric material, the second dielectric material has a third refractive index that is less than the first refractive index, and the first dielectric material alternates with the second dielectric material in a layer stack.

6. The structure of claim 1 further comprising:
a semiconductor substrate; and
a second dielectric layer on the semiconductor substrate
wherein the first waveguide core is positioned on the second dielectric layer, and the first slot extends fully through the first waveguide core to the second dielectric layer.

7. The structure of claim 1 wherein the first waveguide core includes a second slot, and further comprising:
a second dielectric layer inside the second slot.

8. The structure of claim 7 wherein the first waveguide core includes a bend, and the bend is positioned between the first slot and the second slot.

9. The structure of claim 7 wherein the second dielectric layer comprises the first dielectric material.

10. The structure of claim 7 wherein the first slot has a first length, and the second slot has a second length that is equal to the first length.

11. The structure of claim 7 wherein the first slot has a first length, and the second slot has a second length that is less than the first length.

12. The structure of claim 1 further comprising:
a second waveguide core including a second slot, the second waveguide core comprising the material; and
a second dielectric layer comprising a second dielectric material having a third refractive index that is less than the first refractive index, the second dielectric layer including a portion in the second slot.

13. The structure of claim 12 further comprising:
an optical coupler,
wherein the first waveguide core is coupled to the optical coupler, and the second waveguide core is coupled to the optical coupler.

14. The structure of claim 13 wherein the first waveguide core includes a first bend, and the first slot is positioned between the first bend and the optical coupler.

15. The structure of claim 14 wherein the second waveguide core includes a second bend, and the second slot is positioned between the second bend and the optical coupler.

16. The structure of claim 12 wherein the first slot has a first length, and the second slot has a second length that is less than the first length.

17. The structure of claim 12 wherein the second refractive index of the first dielectric layer and the third refractive index of the second dielectric layer are unequal.

18. The structure of claim 12 wherein the second refractive index of the first dielectric layer and the third refractive index of the second dielectric layer are equal.

19. The structure of claim 1 further comprising:
a heater proximate to the first slot.

20. A method of forming a structure for a photonic chip, the method comprising:
forming a first waveguide core including a slot, wherein the first waveguide core comprises a material having a first refractive index; and
forming a dielectric layer that includes a portion positioned inside the slot, wherein the dielectric layer comprises a dielectric material having a second refractive index that is less than the first refractive index.
